(19) United States
(12) Patent Application Publication
(10) Pub. No.: US 2015/0233480 A1
(43) Pub. Date: Aug. 20, 2015

(54) PRESSURE REGULATING VALVES FOR ELECTRICAL GENERATORS

(71) Applicant: Hamilton Sundstrand Corporation, Charlotte, NC (US)

(72) Inventors: Leroy R. Rateike, Rockford, IL (US); Joseph P. Krause, Downers Grove, IL (US); Douglas J. Turner, Rockford, IL (US); Glenn C. Lemmers, JR., Loves Park, IL (US)

(73) Assignee: HAMILTON SUNDSTRAND CORPORATION, Charlotte, NC (US)

(21) Appl. No.: 14/185,023

(22) Filed: Feb. 20, 2014

(51) Int. Cl. F16K 11/078; B01D 29/11

(52) U.S. Cl. CPC F16K 11/078; B01D 29/11

(57) ABSTRACT

A pressure regulating valve includes a valve body and a screen body. The screen body wraps around the valve body and joins itself at a screen joint for coupling the screen body to the valve body. A screen section defined on the screen body strains lubricant entering the valve body.

### BACKGROUND OF THE INVENTION

1. Field of the Invention

The present disclosure relates to electrical generators, and more particularly to lubricant pressure regulating valves for use in electrical generators.

2. Description of Related Art

Many aircraft systems and auxiliary systems include generators. Generators typically include a rotor and a stator each having electric windings. A source of rotation, such as a gas turbine engine, rotates the rotor such that the rotor windings move relative to the stator windings. The relative rotation of the rotor windings adjacent to the stator windings generates electricity.

Generators typically require lubrication for efficient operation. Lubrication systems providing such lubricant to generators generally include a pump for supplying pressurized lubricant to the generator. They also include pressure-regulating valves for maintaining lubricant pressure within a predetermined pressure range. Such pressure regulating valves commonly include a valve sleeve with a valve spool disposed within the valve sleeve. The valve spool moves within the valve sleeve in response to lubricant pressure. The movement of the valve spool regulates lubricant flow between inlet and outlet ports defined in the valve sleeve and fluidly coupled to the generator.

Such conventional methods and systems have generally been considered satisfactory for their intended purpose. However, there is still a need in the art for improved pressure regulating valves. The present disclosure provides a solution for this need.

### SUMMARY OF THE INVENTION

A pressure regulating valve includes a valve body and a screen body. The screen body wraps around the valve body and is joined to itself at a screen joint for coupling the screen body to the valve body, e.g., without welding the screen body to the valve body. A screen section defined on the screen body is configured to strain lubricant entering the valve body.

In certain embodiments, the screen body can include an anti-rotation structure fixing the screen body in rotation about the valve body. The anti-rotation structure can register the screen section with respect to an inlet defined in the valve body for screening lubricant entering the valve body through the inlet. The anti-rotation structure can be defined on the screen joint. The anti-rotation structure can include a tab extending from the screen body. A corresponding notch defined in the valve body can seat the tab of the screen body in the valve body. The notch and the tab can extend axially along the length of the valve body screen body, respectively.

In accordance with certain embodiments, the valve body can have an annular collar bounding a first circumferential edge of the screen body. The annular collar can be a first annular collar and the screen body can have a second annular collar bounding a second circumferential edge of the screen body. It is contemplated that either or both the annular collars can form a seat for an o-ring for sealing the valve body with a housing of an electrical generator.

It is also contemplated that in certain embodiments the anti-rotation structure can include a stake and a stake-receiving aperture for fixing the screen body axially and in rotation with respect to the valve body. The stake can be formed on the valve body and the stake-receiving aperture can be defined in the screen body. The stake can extend radially outward from the valve body for seating within the stake-receiving aperture in the screen body.

It is further contemplated that in certain embodiments the screen joint can include a weld coupling axial edges of the screen body together. The screen section can include wire mesh, a perforated sheet, or any other suitable straining element for separating debris above a predetermined size from lubricant transiting the screen section. The valve body can have an outlet and can include a movable member with a first position and a second position. Lubricant flow between the inlet and the outlet can be greater in the first position than the second position. The outlet can be a scheduled outlet configured for cooperatively regulating lubricant inlet pressure with the movable member.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is an exploded perspective view of an exemplary embodiment of a pressure regulating valve constructed in accordance with the present disclosure, showing a movable member, valve body, and screen body fixed to the valve body;

FIG. 2 is a cut away perspective view of the pressure regulating valve of FIG. 1, showing the screen section of the screen body overlaying an inlet of the valve body; and

FIG. 3 is a plan view of another embodiment of a pressure regulating valve in accordance with the present invention, showing a staked screen body.

### DETAILED DESCRIPTION OF THE PREFERRED EMBODIMENTS

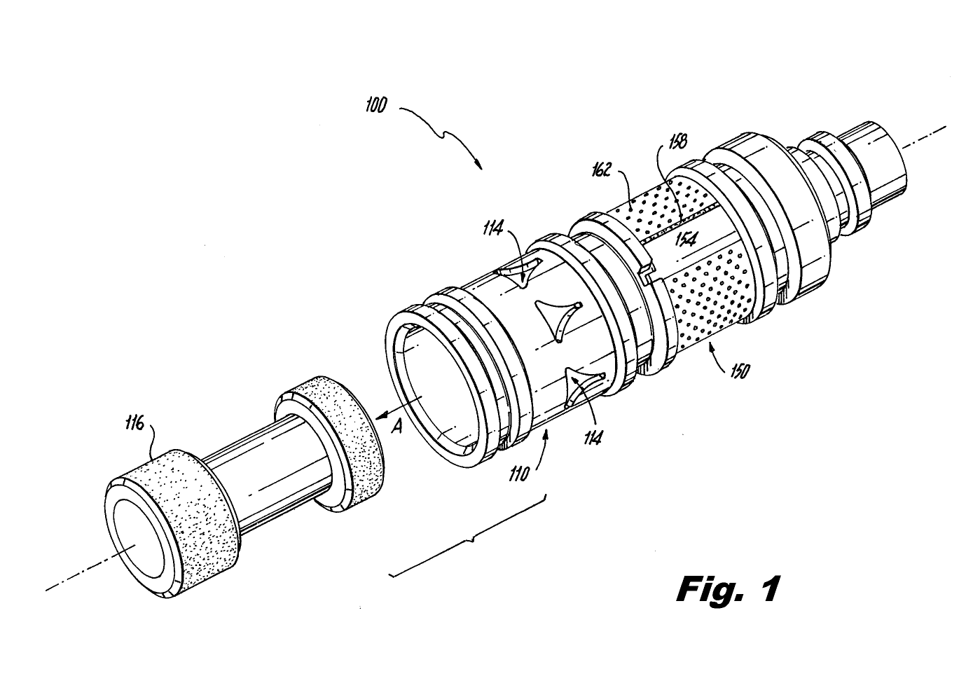

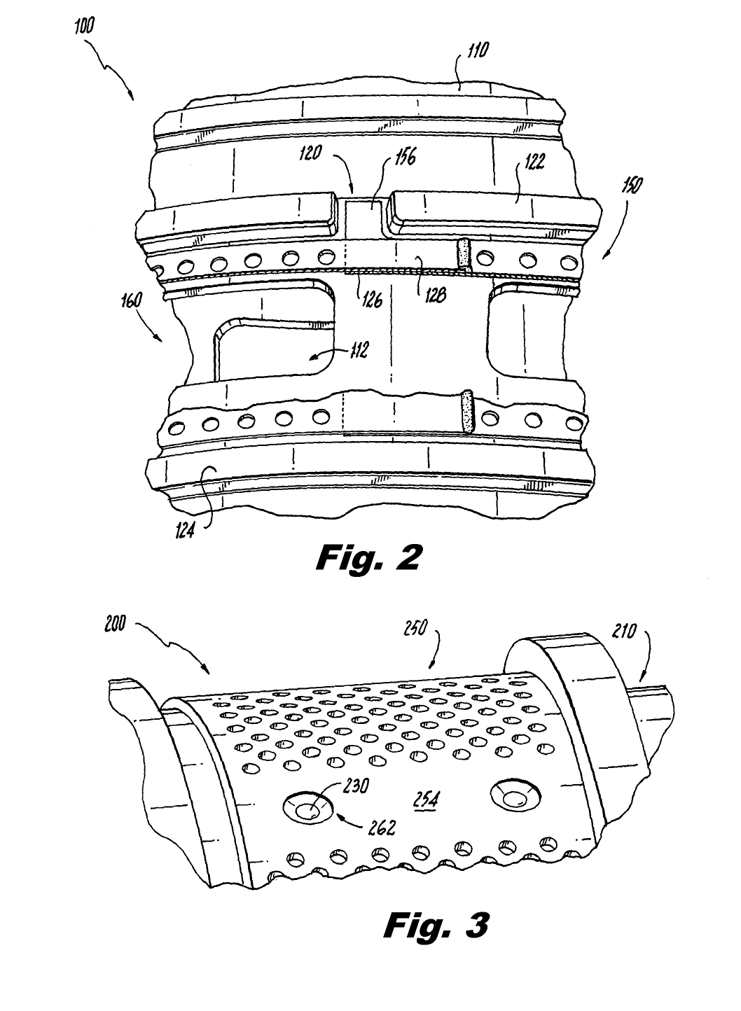

Reference will now be made to the drawings wherein like reference numerals identify similar structural features or aspects of the subject disclosure. For purposes of explanation and illustration, and not limitation, a partial view of an exemplary embodiment of the pressure regulating valve in accordance with the disclosure is shown in FIG. 1 and is designated generally by reference character 100. Other embodiments of pressure regulating valves in accordance with the disclosure, or aspects thereof, are provided in FIGS. 2-3, as will be described. The systems and methods described herein can be used in lubrication systems, such as in generators for aircraft auxiliary systems and components.

Pressure regulating valve 100 includes a valve body 110 and a screen body 150. Valve body 110 has at least one lubricant inlet 112 (shown in FIG. 2), at least one lubricant outlet 114, and an internally disposed movable member 116. Lubricant inlet 112 is radially inward of (underneath) screen body 150. Lubricant outlet 114 is in selective lubricant communication with lubricant inlet 112 through an interior portion of valve body 110. Lubricant outlet 114 is a scheduled outlet and has a circumferential width that increases towards an end of valve body 110. Movable member 116 is slidably received within an interior of valve body 110 and movable in relation to lubricant inlet 112 and lubricant outlet 114.

Movable member 116 is movable between a first axial position and a second axial position within the interior of valve body 110. Movement of movable member 116 cooperates with the shape of outlet 114 for varying lubricant flow through valve body 110 in response to lubricant pressure at lubricant inlet 112. Lubricant flow through valve 100 is greater when movable member 116 is in its first axial position than when movable member 116 is in its second position. Other aspects of the movable member 116, e.g. valve spools and valve sleeves, are described in U.S. Pat. No. 8,485, 218, the contents of which are incorporated herein by reference in their entirety.

Screen body 150 includes a screen section 152 and a screen joint 154. Screen section 152 is configured for straining lubricant entering valve body 110 through lubricant inlet 112. This prevents debris that may be entrained in the lubricant from entering into valve body 110 and interfering with operation of movable member 116. In embodiments, screen section 152 includes wire mesh 160 (shown in FIG. 2), perforated sheet 162 (shown in FIG. 1), or any other suitable straining element for separating debris above a predetermined size from lubricant transiting screen section 152.

Axial edges of screen body 150 connect to one another to form an axially extending screen joint 154 extending axially along pressure regulating valve 100, thereby joining screen body 150 to itself. Screen joint 154 includes a weld 158 joining respective axial edges of the screen body to one another. It is also contemplated that the screen joint 154 can also be crimped or brazed. This makes screen body 150 integral with and inseparable from valve body 110, indirectly coupling screen body 150 to valve body 110 without directly welding or fastening screen body 150 to valve body 110.

With reference to FIG. 2, screen body 150 includes an anti-rotation structure 156 configured for fixing screen body 150 in rotation about valve body 110. Valve body 110 defines a notch 120 corresponding to anti-rotation structure 156 and configured for seating anti-rotation structure 156. Seating anti-rotation structure 156 in notch 120 registers screen section 152 (shown in FIG. 1) with respect to inlet 112 of valve body 110 for screening lubricant entering valve body 110 through inlet 112. As illustrated, a single anti-rotation structure 156 is defined on screen joint 154 and can be a tab or key structure for example extending axially along valve body 110. Two or more anti-rotation structure 156 can also be defined on screen body 150 on screen joint 154, screen section 152 or both screen joint 154 and screen section 152.

Valve body 110 has a first annular collar 122 and a second annular collar 124. First annular collar 122 bounds a first circumferential edge 126 of screen body. Second annular collar 124 bounds a second circumferential edge 128 of the screen body. First annular collar 122 limiting displacement of screen body 150 in a first direction along axis A (shown in FIG. 1) and second annular collar 124 limits displacement of screen body 150 in an opposite second direction along axis A (shown in FIG. 1). Notch 120 can be defined in either or both of first and second collar 122 or 124. First and second collars 122 and 124 can be seats o-ring gaskets configured for sealing valve body 110 in a housing.

With reference to FIG. 3, another embodiment of a pressure regulating valve 200 is shown. Pressure regulating valve 200 is similar to pressure regulating valve 100 and additionally includes a valve body 210 with a stake 230. Stake 230 extends radially outward from valve body 210 at an angle from axis A (shown in FIG. 1). A screen body 250 with a stake receiving aperture 262 wraps around valve body 210 such that stake 230 seats in stake-receiving aperture 262. This fixes screen body 250 in both rotation as well axially with respect to valve body 210. As illustrated in FIG. 2, two stakes 230 and stake receiving apertures 262 fix screen body 250 to valve body 210. As will be appreciated, any suitable number of stakes and stake receiving apertures can be used for securing screen body 250 to valve body 210.

Conventional pressure regulating valves do not include a screen body over their inlet. Since some lubrication systems can include entrained debris, debris can become lodged within the valve body and potentially restrict the movement of movable elements within the valve. Embodiments of valves described herein include an integral (inseparable) screen body, preventing debris entry into the valve. Embodiments of valves described herein also have screen bodies attached by welding to the screen body without developing a heat-affected zone on the valve body. This can prevent microcracking or other damage to valve body 110 from exposure to heat during welding that can potentially reduce the valve operation efficiency. Embodiments of valves described herein can also fix the screen body in rotation with respect to the valve body. This can prevent the generation of wear debris by preventing lubricant flowing through the screen from causing the screen to rotate about the valve body, thereby generating debris and eroding the valve body or screen.

The methods and systems of the present disclosure, as described above and shown in the drawings, provide for pressure regulating valves with superior properties including integral screen bodies that fixedly attach to the valve body indirectly and without welding or fasteners. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. A pressure regulating valve, comprising:
a valve body; and
a screen body with a screen section for straining lubricant, wherein the screen body wraps around the valve body and is joined to itself at a screen joint for coupling the screen body to the valve body.

2. A valve as recited in claim 1, wherein the screen body further includes an anti-rotation structure, wherein the anti-rotation structure fixes the screen body in rotation about the valve body and registers the screen section to an inlet of the valve body for screening lubricant entering the inlet.

3. A valve as recited in claim 2, wherein the anti-rotation structure is formed on the screen joint.

4. A valve as recited in claim 2, wherein the anti-rotation structure includes a tab formed on the screen body, wherein the valve body includes a notch defined in the valve body, and wherein the tab of the screen body seats in the notch of the screen body.

5. A valve as recited in claim 4, wherein the notch extends axially along a length of the valve body.

6. A valve as recited in claim 2, wherein the anti-rotation structure includes a stake formed on the valve body and received within a stake-receiving aperture defined by the screen body.

7. A valve as recited in claim 6, wherein the stake extends radially outward from the valve body.

8. A valve as recited in claim 1, wherein the valve body defines an annular collar bounding a first circumferential edge of the screen body.

9. A valve as recited in claim 8, wherein the annular collar is a first annular collar and further including a second annular collar defined by the valve body and bounding a second circumferential edge of the screen body.

10. A valve as recited in claim 1, wherein the joint includes a weld coupling axial edges of the screen body.

11. A valve as recited in claim 1, wherein the screen section includes wire mesh or a perforated sheet.

12. A pressure regulating valve, comprising:
a valve body with an inlet and an outlet;
a movable member disposed within the valve movable between a first position and a second position for regulating lubricant pressure at the inlet; and
a screen body with a screen section for straining lubricant, wherein the screen body wraps around the valve body and is joined to itself at a screen joint for coupling the screen body to the valve body.

13. A valve as recited in claim 12, wherein the outlet is a scheduled outlet.

14. A valve as recited in claim 12, further including an anti-rotation structure formed from an axially extending tab on the screen body and a notch defined in the valve body, wherein the tab seats in the notch, wherein the anti-rotation structure fixes the screen about the valve body and registers the screen section with the inlet for screening lubricant entering the valve body.

15. A valve as recited in claim 12, further including an anti-rotation structure formed from an radially extending stake on the screen body and a stake-receiving aperture defined by the screen body, wherein the anti-rotation structure fixes the screen about the valve body and registers the screen section with the inlet for screening lubricant entering the valve body.
